(19) United States
(12) Patent Application Publication
(10) Pub. No.: US 2024/0286093 A1
(43) Pub. Date: Aug. 29, 2024

(54) SELF-CONTAINED DEVICE FOR GENERATING A VISCOUS FOAM

(71) Applicant: COMMISSARIAT À L'ÉNERGIE ATOMIQUE ET AUX ÉNERGIES ALTERNATIVES, Paris (FR)

(72) Inventors: Fabien FRANCES, Saint-Julien-De-Peyrolas (FR); Pierre VENDITTI, Saint-Paulet-De-Caisson (FR); Célia LEPEYTRE, Rochefort-du-Gard (FR); Agnès GRANDJEAN, Saint-Marcel-De-Careiret (FR)

(21) Appl. No.: 18/570,763

(22) PCT Filed: Jun. 14, 2022
(86) PCT No.: PCT/FR2022/051139

§ 371 Date: Dec. 15, 2023

(30) Foreign Application Priority Data
Jun. 16, 2021 (FR) FR2106378

(51) Int. Cl. B01F 25/452; B01F 23/235; B01F 35/21; B01F 35/71; B01F 35/75; B05B 7/00; B05B 7/24; B05B 12/00; B08B 3/00

(52) U.S. Cl. CPC B01F 25/45241; B01F 23/235; B01F 35/2113; B01F 35/7176; B01F 35/754; B05B 7/0043; B05B 7/2421; B05B 7/2464; B05B 12/006; B08B 3/003; B01F 2215/0431

(57) ABSTRACT

This foam-generating device is easily transportable, free from fluid or power supply constraints, and able to supply a foam such as viscous foam with a high (low liquid fraction), time-invariant (low liquid fraction). The gas is withdrawn compressed from a cylinder, and a fixed fraction of its flow is used to drive a pneumatic pump which draws in the foaming liquid. The foam is formed in a mixer containing free-moving solids shortly before the ejection end of the device. The mixer has highly mobile balls in a cage of much larger dimensions; it is suitable for producing foam with a high overrun. Application: decontamination and depollution of large surfaces, buildings or indoor or outdoor structures.

The present invention relates to a self-contained device for generating a viscous foam.

It is used in particular in decontamination or depollution work where foam has to be applied to large areas that can be sharply inclined or vertical, belonging for example to buildings, or in almost closed volumes, which may be difficult to access, and remain on these surfaces for a sufficiently long time to act on the polluting substances, without running or deteriorating in another way.

For this, foams called viscous foams are appreciated; that is to say enriched with a gelling agent which increases the physical stability of the foams and makes them less likely to run off even very inclined or vertical surfaces. These two characteristics allow the foam to act for a sufficient time on the surface to be treated that it covers. Examples are given in FR 2 841 802 A1. One of the drawbacks thereof is that they are difficult to manufacture from a liquid foaming solution, specifically because of the high viscosity of this solution. The foam generating apparatuses are generally provided for conventional foams, and they are not suitable for viscous foams. They in particular do not allow sustainably guaranteeing a high expansion of the produced foam, that is to say a low liquid fraction in the foam (for example less than 10% by volume); a lower expansion has in particular the drawback of using an excess of the liquid products for the same volume of foam, and of giving fewer small, more lasting bubbles.

An example of a foam-generating device is described in WO 2013/067401 A2; this device is partially portable, but it is designed for ordinary foams used against fires.

U.S. Pat. No. 5,623,995 A, US2010/175897 A1 and CN110251865 A describe other foam generating and spraying devices.

FR2889085 A1 and WO2019/011513 A1 describe mixers of the constituents of the foam, capable of manufacturing the latter in spraying devices such as those of the documents mentioned above. These mixers comprise beds of solid bodies composed of superimposed layers; the constituents of the foam are forced to flow through the beds, and they are mixed in the interstices of the solid bodies by forming the foam. The compact beds described in these documents are nevertheless not very suitable for producing high-expansion foams.

An object of the invention is to manufacture foams, in particular special high-expansion foams, reliably, at a significant flow, by means of a suitable generator and whose operation is stable.

Other objects of the invention are:
being able to transport the apparatus easily in places which are difficult to access and do not have any source of supply, such as water or electricity;
providing the operator with certain safety benefits.

According to a general definition, the invention relates to a foam-generating device, comprising a reservoir of foaming liquid, a compressed gas cylinder, a first pipe out of the reservoir and passing through a pneumatic pump while being connected to suction and discharge ports of said pneumatic pump, a second pipe out of the cylinder and passing through an expansion valve, the first pipe and the second pipe being joined at a junction; a pipe for transporting a mixture of the foaming liquid and the compressed gas extending between the junction and a foam ejection end (7); a mixer of the foaming liquid and the compressed gas, at an inlet of which the first pipe and the second pipe terminate and in which the foam is formed, and located on the pipe for transporting the mixture between the junction and the ejection end; the second pipe comprising a bifurcation leading to a port for starting the pneumatic pump, characterised in that the mixer comprises a cylindrical wall open at the two axial ends and through which the mixture passes between said ends axial, a cage formed in the cylindrical wall, and at least one solid body which is free to move in the cage, the at least one solid body consisting of 1 to 40 balls, constructed of rigid materials, and in that the cage is 10 to 400 mm in length, 10 to 100 mm in diameter, and the balls are 2 to 20 mm in diameter.

This device, where the compressed gas is used both to manufacture the foam and to suck the foaming liquid out of the reservoir thereof, allows dispensing with the need for a power supply to the device implying either the constraint of an external supply by cables, or a heavy battery. The flow rate of the sucked liquid, conditioned by the energy supplied to the pump, is proportional to the pressure of the compressed gas, and the flow rate of the compressed gas used to manufacture the foam is also proportional to this pressure. The stability of the expansion of the foam, that is to say of the value of its liquid fraction, is therefore guaranteed without any adjustment. The mixer integrated into the device is well adapted to produce a foam having the required qualities. The balls being in small number in the cage and of dimensions which are much smaller than it, do not form superimposed layers therein, but on the contrary remain free and perform independent and significant movements, capable of giving a high expansion of the foam.

According to certain optional improvements of this design:
the device includes a pressure gauge for measuring the pressure of the compressed gas in the cylinder;
the pipe for transporting the mixture comprises a flexible nozzle;
the device comprises a single control lever, disposed on the nozzle, for opening the nozzle and ejecting the foam;
the cage is delimited by two gates succeeding each other in the cylindrical wall;
the device is mounted on a portable frame or a rolling cart, and completely independent, in service, of external supplies, in particular of electricity or fluids.

The invention is well adapted to the generation of foams containing a gelling agent.

The invention will now be described in its different aspects, features and advantages, by means of the following figures, which illustrate a particular embodiment, given for purely illustrative purposes:

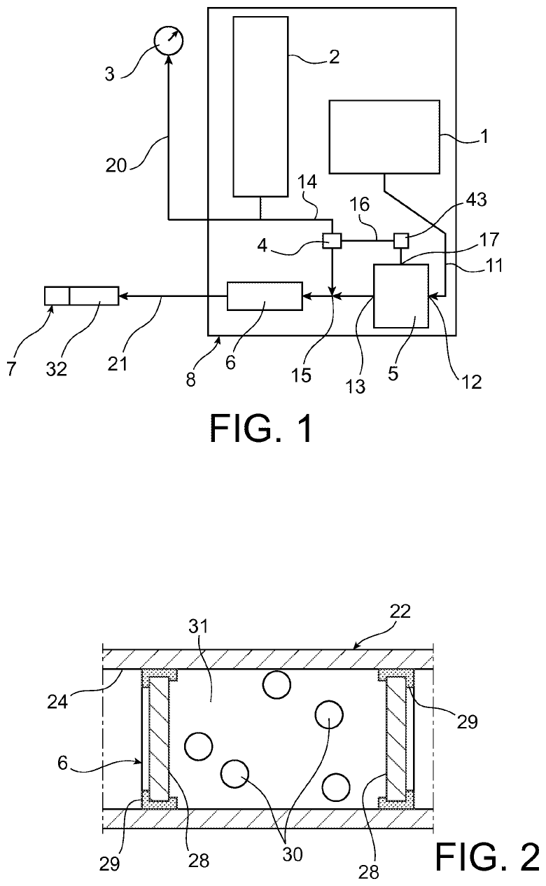

FIG. 1 is a diagram of an embodiment of the invention;

FIG. 2 represents the mixer;

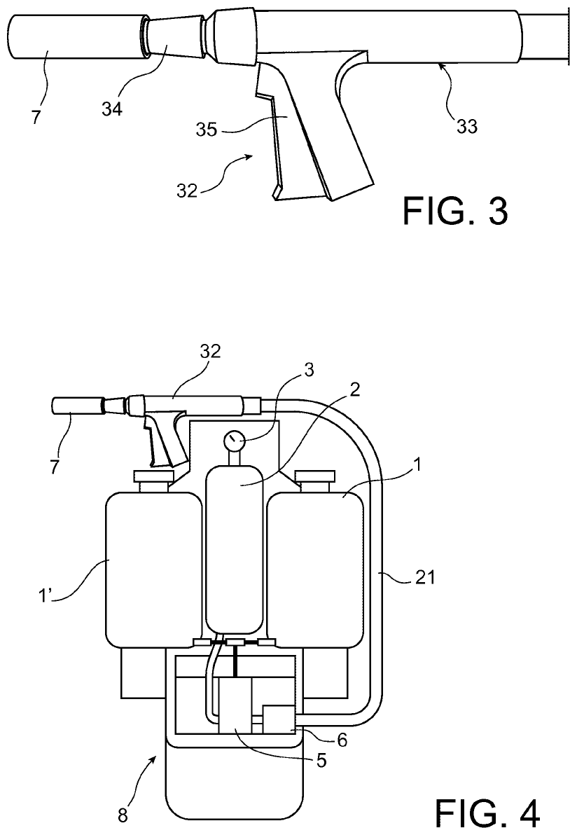

FIG. 3 represents the end of the spray gun;

FIG. 4 illustrates a concrete arrangement of the embodiment.

Referring to FIG. 1, the apparatus comprises a reservoir 1 of liquid foaming solution, a compressed gas cylinder 2 of, a pressure gauge 3, a main expansion valve 4, a pneumatic pump 5, a mixer 6, a foam ejection end 7, and a frame 8. A first pipe 11 connects an outlet port of the reservoir 1 to a suction port 12 of the pneumatic pump 5; it emerges from the pneumatic pump 5 through the discharge port 13 thereof, passes through the mixer 6 and ends at the end 7. A second pipe 14 connects an outlet port of the cylinder 2 to the main expansion valve 4, then joins the first pipe 11 at a junction 15 made between the discharge port of the pneumatic pump 5 and the mixer 6. A bifurcation 16 of the second pipe 14 leads to a port 17 for moving the rotor of the pneumatic pump 5 (possibly via a second expansion valve 43 to independently adjust the pressure at this location). The bifurcation 16 leaves the second pipe 14 just downstream of the main expansion valve 4 and therefore transports lightly compressed air at constant pressure (7 bars for example). The pressure gauge 3 is connected to the second pipe 14 by a pressure sensing pipe 20, upstream of the main expansion valve 4, and it therefore allows measuring the pressure of the gas at the outlet of the cylinder 2 and evaluating the filling thereof.

The frame 8 supports the reservoir 1, the cylinder 2, the main expansion valve, the pneumatic pump 5, the first pipe 11 and the second pipe 14. As shown in FIG. 4, the frame 8 can be vertical and belong to a backpack worn by the operator of the device; the frame 8 can also be a rolling cart, for example. The foam ejection end 7 is not fixed to the frame 8, but it is located at the end of a flexible nozzle 21, which the operator holds. The nozzle 21 extends between the end 7, on the one hand, and the junction 15, on the other hand.

The mixer 6 is located on the path of the mixture of liquid and compressed air between the junction 15 and the end 7, and it is represented in FIG. 2. It comprises two planar gates 28 succeeding each other in the drilling 24 of a cylindrical wall and occupying the entire section thereof, two seals 29 to which the gates 28 are respectively fixed and which are used as a support for the wall of the drilling 24, and spherical and rigid balls 30 which are free to move between the gates 28. The seals 29 are used to hold the gates 28 in place and to form a cage 31 therebetween, which is further delimited by the wall of the drilling 24, and in which the balls 30 are retained. They also force all fluids circulating in the drilling 24 to pass through the interior of the cage 31.

This type of mixer comprising balls, or more generally solid bodies, which are free in a cage crossed by the previously mixed fluids has proven to be very effective in producing foams whose expansion is well determined and possibly high, that is to say with low liquid fraction. It is particularly suitable for the manufacture of viscous foams. The cage 31 can be 10 to 400 mm in length, 10 to 100 mm in diameter, and the balls 30 can be 2 to 20 mm in diameter. Free and independent movements of large amplitude, of the balls 30 being sought to give a high expansion, a very low filling of the cage 31 by the balls 30 is sought. Advantageously, the balls 30 do not form superimposed layers when at rest. They are 1 to 40 in number, with a diameter of 2 to 10 times smaller than the diameter (or the dimensions transverse to the axis X-X) of the cage 31; more advantageously, of 4 to 8 times smaller than this diameter; and at best, about 5 times smaller.

FIG. 3 shows that the end 7 is attached to the front end of a barrel of a gun 32 held by the operator, whose rear end of which is joined to the nozzle 21. The operator releases the nozzle 21 and triggers the spraying of foam by pressing a trigger 35 of the gun 32.

FIG. 4 illustrates a possible arrangement of equipment on the frame 8, where there is still a spare reservoir 1′, used when the first (the reservoir 1) has been emptied, is further represented.

This is how the device works and what its advantages are. As the device has no constraints, that is to say no supply from the outside, the operator can put it on or carry it without constraint in remote or inaccessible places. He grabs the nozzle 21 by the gun 32 and presses the trigger 35 when he is in front of the surface to be covered with foam. Releasing the nozzle 21 allows the compressed air to flow through the second pipe 14. A portion of the flow passes through the pneumatic pump 5, turns it on and is used to suck an invariable flow, proportional to the air flow passing through the pump 5, of the foaming solution out of the reservoir 1. The pumped foaming solution and the main flow of compressed air, which is directed towards the nozzle 21, are joined at the junction 15, upstream of the mixer 6. Here too, the flow rate of the foaming solution and that of the compressed air which is mixed with it are proportional and therefore have an invariable ratio, determined by the physical characteristics of the fluids and the device. The foam is formed by mixing the air and the foaming solution, by passing through the mixer 6, which is very effective to obtain a high expansion foam, sought among others for viscous foams.

Some additional indications, of a concrete nature, are given below to describe in more detail a particular example of this embodiment of the device and its performance.

Cylinder 2: capacity of 31, starting pressure of 300 bars;

Reservoirs 1 or 1′: capacity of 8l each;

Main expansion valve 4: reduces the pressure to 7 bars;

Second expansion valve 43: reduces the pressure to 4 bars;

Mixer 6: diameter and length of the cage 31: from 10 to 100 mm and from 10 to 400 mm;

Rigid balls 30: from 1 to 40, from 2 to 20 mm in diameter;

Foaming solution: water, with Glucopon 215UP [BASF] at 10 g/l, and Xanthan Gum (G1253) [Sigma Aldrich] at 3 g/l;

Layer sprayed onto vertical surface: 10 m², 1 cm thick, in 120 s; sliding velocity less than 1 cm/min. In the case where the foam is used to fill a volume, it must be maintained for at least 120 minutes.

Expansion of the obtained foam: about 16.7 (approximately 100 litres of foam produced per 6 litres of the foaming solution used).

The balls 30 could be replaced by another solid body that can move freely in the cage 31, and their number could also be different, a single solid body being possible.

1. A foam-generating device, comprising a reservoir of a foaming liquid, a compressed gas cylinder, a first pipe out of the reservoir and passing through a pneumatic pump while being connected to suction and discharge ports of said pneumatic pump, a second pipe out of the cylinder and passing through an expansion valve, the first pipe and the second pipe being joined at a junction; a pipe for transporting a mixture of the foaming liquid and the compressed gas extending between the junction and a foam ejection end; a mixer of the foaming liquid and the compressed gas, in which the foam is formed, and located on the pipe for transporting the mixture between the junction and the ejection end; the second pipe comprising a bifurcation leading to a port for starting the pneumatic pump, wherein the mixer comprises a cylindrical wall open at the two axial ends and through which the mixture passes between said ends axial, a cage formed in the cylindrical wall, and at least one solid body which is free to move in the cage, the at least one solid body consisting of 1 to 40 balls, constructed of rigid materials, and in that the cage is 10 to 400 mm in length, 10 to 100 mm in diameter, and the balls are 2 to 20 mm in diameter.

2. The foam-generating device according to claim 1, further comprising a pressure gauge for measuring the pressure of the compressed gas in the cylinder.

3. The foam-generating device according to claim 1, wherein that the pipe for transporting the mixture comprises a flexible nozzle.

4. The foam-generating device according to claim 3, further comprising a single control lever, disposed on the nozzle, for opening the nozzle and ejecting the foam.

5. The foam-generating device according to claim 1, wherein the cage is delimited by two gates succeeding each other in the cylindrical wall.

6. The foam-generating device according to claim 1, wherein the device is mounted on a portable frame, and completely independent, in service, of external supplies, in particular of electricity or fluids.

7. A method comprising application of a claim 1 to the manufacture and the spraying onto a surface of a foam containing a gelling agent.
